(19) United States
(12) Patent Application Publication
(10) Pub. No.: US 2015/0240507 A1
(43) Pub. Date: Aug. 27, 2015

(54) Exercise System Employed in an Exercise Facility

(71) Applicant: Triharder Industries LLC, New York, NY (US)

(72) Inventor: Shawn Kolodny, New York, NY (US)

(21) Appl. No.: 14/191,003

(22) Filed: Feb. 26, 2014

(51) Int. Cl. E04H 3/14; G06Q 10/02; E04H 3/16

(52) U.S. Cl. CPC E04H 3/14; E04H 3/16; G06Q 10/02

(57) ABSTRACT

An exercise system employed in an exercise facility includes multiple rooms. The system includes at least one swimming pool, in a first room, cycling exercise equipment, in a second room, running exercise equipment, in a third room. At least one computer provides a scheduler for scheduling a sequence of at least two of, swim, cycle and running activities, occurring in the first second and third rooms of the facility, in providing exercise for a user, in response to command. A transition room provides access to the first, second and third rooms and stores clothes and equipment for use in the swim, cycle and running activities.

### TECHNICAL FIELD

An exercise system and facility concerns support of exercise components usable to provide a triathlon type exercise regimen, for example.

### BACKGROUND

Known exercise facilities typically address individual activities by providing weight lifting, treadmills for running and other types of exercise such as ski type exercise and cycling. Known exercise facilities may also have a general pool for swimming. The activities and room layout in such known facilities are generally not structured and organized to comprehensively address the requirements of a particular sport or regimen such as a triathlon or pentathlon, for example.

### SUMMARY

An exercise system employed in an exercise facility includes multiple rooms. The system includes at least one swimming pool, in a first room, cycling exercise equipment, in a second room, running exercise equipment, in a third room. At least one computer provides a scheduler for scheduling a sequence of at least two of, swim, cycle and running activities, occurring in the first second and third rooms of the facility, in providing exercise for a user, in response to command. A transition room provides access to the first, second and third rooms and stores clothes and equipment for use in the swim, cycle and running activities.

### BRIEF DESCRIPTION OF THE DRAWINGS

FIG. 1 shows a system employed in an exercise facility including multiple rooms, according to invention principles.

FIG. 2 shows a flowchart of a process employed by a user in using the system and facility, according to invention principles.

FIG. 3 shows a layout of the facility and progress of a user through the facility during a class, according to invention principles.

FIG. 4 shows a UI display image enabling a user to purchase classes, according to invention principles.

FIG. 5 shows a UI display image showing a Home screen and enabling user login, according to invention principles.

FIG. 6 shows a UI display image presenting user performance data, according to invention principles.

FIG. 7 shows a UI display image enabling a user to reserve particular exercise equipment, according to invention principles.

FIG. 8 shows a UI display image enabling a user to schedule exercise classes, according to invention principles.

FIG. 9 shows a flowchart of a process used by a system employed in an exercise facility including multiple rooms, according to invention principles.

### DETAILED DESCRIPTION

An exercise system comprises a specialized gym and workout program based on a Triathlon or other program such as a Pentathlon, for example. Although described herein in the context of a Triathlon, this is exemplary only and one of ordinary skill will readily appreciate the system is applicable to other exercise programs involving sequential segments of exercise of particular types. The system supports workout in a customized gym facility enhanced with systems to track and monitor user performance individually over time. In an embodiment, workouts are based on a Swim, Bike, Run routine of a Triathlon but also shorter combination classes (or Bricks), such as Swim and Bike, Swim and Run, or Bike and Run, for example. The system supports community engagement both physically and online where a participant is able to compare results as well as compete with other participants based on a variety of variables (including age, weight, experience, time, distance, for example).

Classes are based on a fixed time schedule so classes operate similar schedules such as, a 15 minutes swim, a 25 minutes bike and a 20 minutes run, with 5 minute transitions between each activity. A full triathlon class is 1 hour of exercise (10 minutes of transition) Brick classes run from 35 minutes (Swim and Run) to 45 minutes (Bike and Run). In addition, ironman classes are provided with double theses time. In an embodiment, classes occur each hour where an instructor goes through the exercises with the users, coaching and teaching along the way. User distances, resistances and other data are tracked and recorded so users can keep track of personal performance, as well as compete against others in the class, as well as other users in the gym. The exercise facility provides leaderboards within the gym showing user performance in a variety of categories. The Gym components include, Check-in, Store, Locker rooms, Swimming Room, Biking Room, Running room and Transition room. As used herein the term “room” is a part or division of a building substantially enclosed by walls, floor, and ceiling. The term “substantially” herein means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The following description refers to specific numbers of equipment, pools, bikes and treadmills but this is exemplary only. It will be readily appreciated that different numbers of machines/equipment may be used and different types of machines and equipment may be used for other types of exercise and the numbers and types of machines, pools may vary from facility to facility.

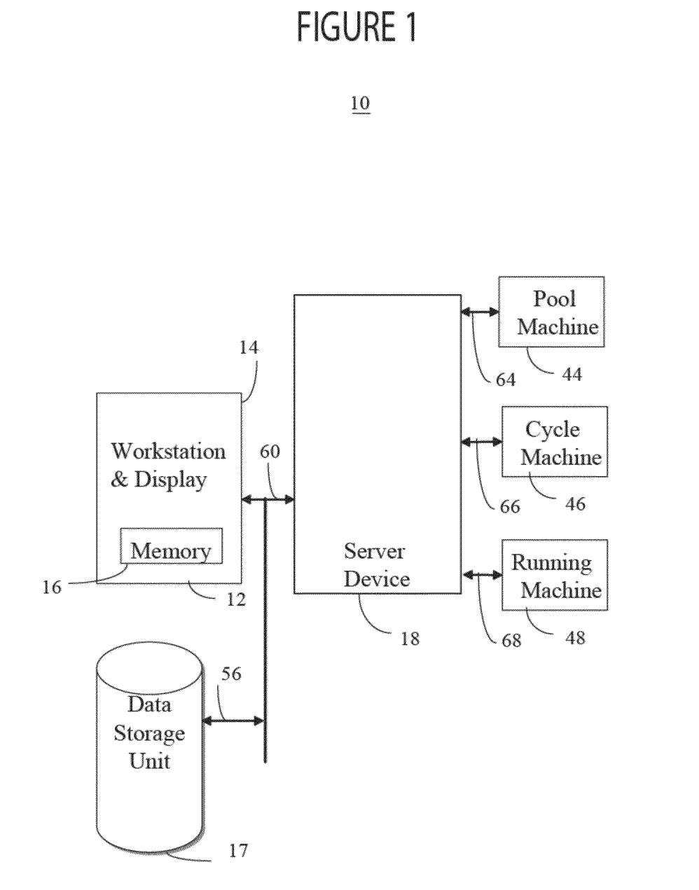

FIG. 1 shows system 10 employed in an exercise facility including multiple rooms. The system includes at least one swimming pool including a swimming machine 44 providing an adjustable speed water flow in which a user swims, in a first room, cycling exercise equipment 46, in a second room and running exercise equipment 48, in a third room. An additional transition room enables access to the first, second and third rooms and stores clothes and equipment for use in swim, cycle and running activities. At least one computer (server) 18 provides a scheduler executing schedule program code for scheduling a sequence of at least two of, swim, cycle and running activities, occurring in the first second and third rooms of the facility, in providing exercise for a user. The at least one computer 18 processes data acquired from the swimming machine, the cycling exercise equipment and the running exercise equipment to provide information indicating user performance to a user via presentation on a display of workstation 14. The acquired data includes, distances, resistances, time durations and speeds and server 18 processes the acquired data to derive information indicating user performance. Workstation and display 14 includes internal memory 16 supporting processing. Repository 17 stores performance and other data used in processing by server 18 and workstation 14. Server 18 bidirectionally communicates with workstation 14, repository 17, machine 44, equipment 46 and equipment 48 via bidirectional links 56, 60, 64, 66 and 68 comprising Local Area Network (LAN), Internet links or other communication links in a wired or wireless configuration. Further, the processing units of system 10 may be located locally or remotely with respect to one another in a distributed arrangement.

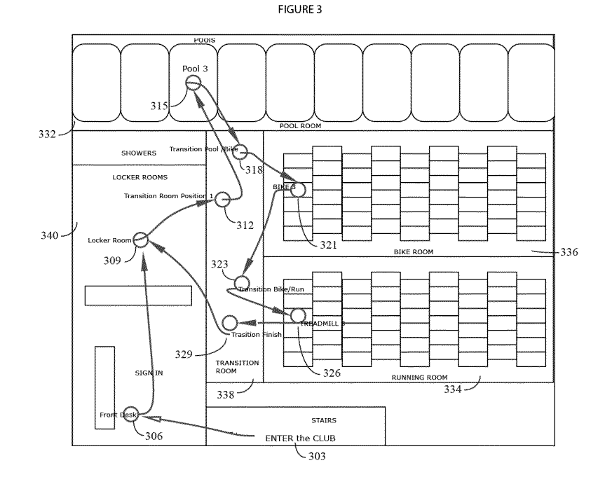

FIG. 3 shows a layout of the facility and progress of a user through the facility during a class. Upon entering the facility at step 303 a user proceeds to the front desk 306 and after sign in and use of the locker room 340 with private shower facilities at step 309, selects clothes and equipment for a first activity (swimming) at a swim position in the transition room 338 in step 312. The facility swimming room 332 is outfitted with 10 endless pools (usually 5-10 pools are used) comprising small self-contained pools with a current to swim against. The Swim is a first and a difficult part of triathlon training

Due to space requirements there are typically a limited number of pools compared with number of bikes and treadmills. A workout class begins with the swim for 10-15 minutes. The pools are used on average for two 10-15 minute sessions per hour. There will be some classes with longer swims. During downtime, pools can be rented for private swim training and instruction. The transition room 338 joins the workout rooms. It is where users change clothes and equipment for each exercise, similar to the transition in a real triathlon. The transition room 338 has a series of identified (e.g., numbered) storage areas that are correlated to pool, bike and treadmill identifiers (e.g., number). So a user is allocated pool number two, locker number two, bike number two, and treadmill number two, for example. A user loads equipment and clothes into their storage area before the class begins, and return to it after each exercise (Swim, Bike, Run). Classes are set up so transitions occur at similar times.

A user is allocated to swimming pool 3 in the swimming room 332, cycle equipment 3 in a bike room 336 and running treadmill 3 in a running room 334. In response to clothes and equipment selection, the user performs a swim exercise in endless pool 3 in step 315, returns to a cycle transition room position in step 318 where cycle equipment and clothes are selected and performs a cycling activity in the bike room in step 321. The bike room 336 has up to 55 bikes, up to 54 for users and 1 for an instructor, for example. The bikes are advantageously configured to be in elevated rows of 4-8 bikes, each row is offset to the one in front of it, advantageously creating the feeling of a pack of bikers in a race. An instructor is in the first row, slightly elevated but facing the same direction as the other cyclists. The Front wall of the bike room presents a selectable projection video of a scene from different triathlons from a first person perspective, edited to go with the class, (i.e. hill climb, straight, downhill). This allows cyclists to feel as if they are part of a real race. Each class is associated with, and is named after, a different famous triathlon course. Information about the users ride (torque and distance, for example) and performance is recorded. Displays in the bike room show the class performance of the class members to one another categorized by different variables.

Following completion of the cycle activity, the user returns to a run transition room position in step 323 where running equipment and clothes are selected and performs a running activity in step 326. The running room 334 has up to 55 treadmills, up to 54 for users and 1 for an instructor, for example. The treadmills are in elevated rows of 4-8 treadmills with each row offset with respect to the one in front, creating the feeling of a pack of runners in a race. An instructor is in the first row, slightly elevated but facing the same direction as the other runners. The Front wall of the running room presents a selectable projection video of a scene from different triathlons from a first person perspective, edited to go with the class, (i.e. street scene, coastal scene). This allows runners to feel as if they are part of a real race. Each class is associated with, and is named after, a different famous triathlon course. Information about the users run (speed and distance, for example) and performance is recorded. Displays in the running room show the class performance of the class members to one another categorized by different variables. Upon completion of the run activity, the user returns equipment and clothes at a transition room finish position in step 329 and returns to the locker room to change and finish. System 10 acquires pertinent information from the pools bikes and treadmills, including but not limited to distance, resistance, incline, speed, torque and water velocity, for example. System 10 processes and compiles the acquired data per user to create performance statistics, advanced user profiles and competition metrics. This enables users to improve performance, compete against others, and creates competition amongst the exercise community.

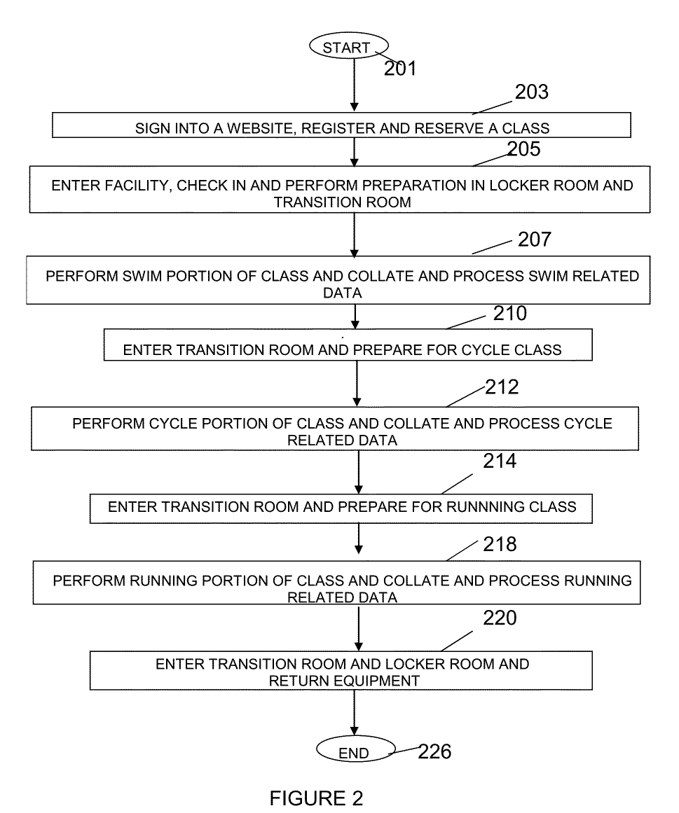

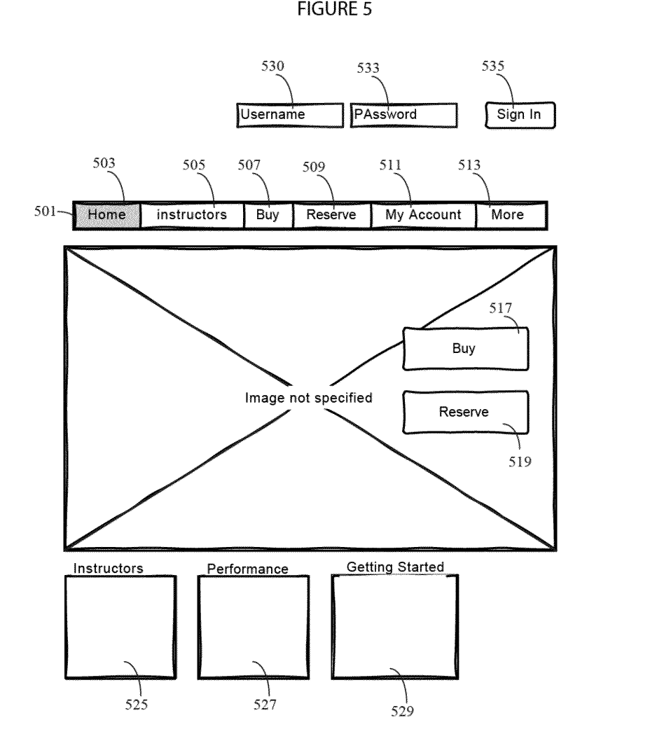

FIG. 2 shows a flowchart of a process employed by a user in using the system and facility. In step 203 following the start at step 201, a user signs into the facility website to register, purchase classes, and schedule class times and provides basic contact, personal and credit card information. FIG. 5 shows a UI display image showing a Home screen and enabling user login and including intra-web site browsing tab bar 501 common to most (or all) of the UI images provided. Tab bar 501 includes navigation tabs, Home 503, Instructors 505, Buy 507, Reserve 509, My Account 511 and More 513 (such as scheduling) enabling navigation to web pages supporting these functions. A user signs in via username and password boxes 530 and 533 as well as button 535. Duplicate Buy, Reserve and Instructors links are provided in elements 517, 519 and 525. A user may access user specific Performance and Getting Started information via link elements 527 and 529.

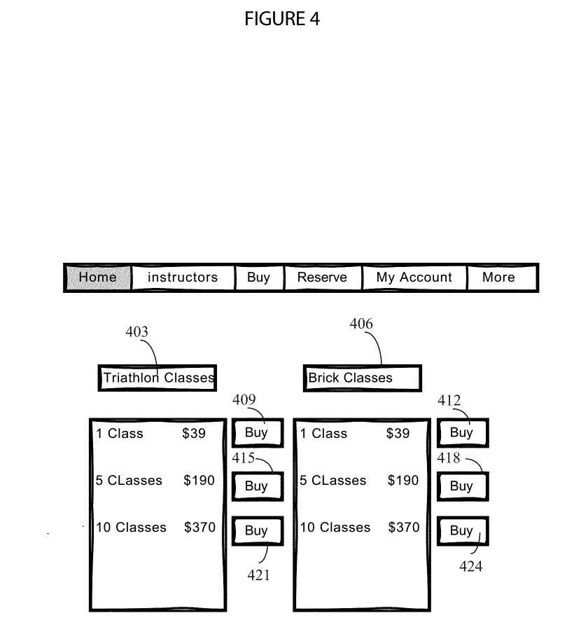

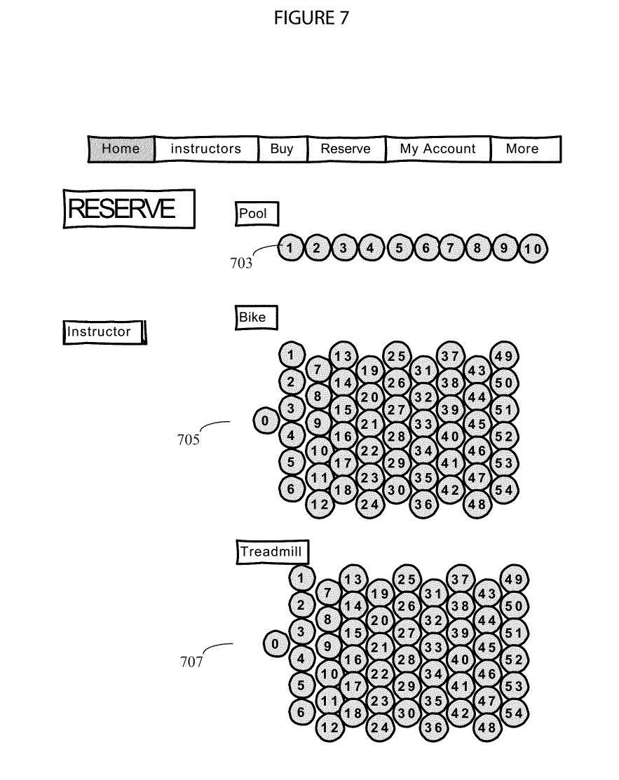

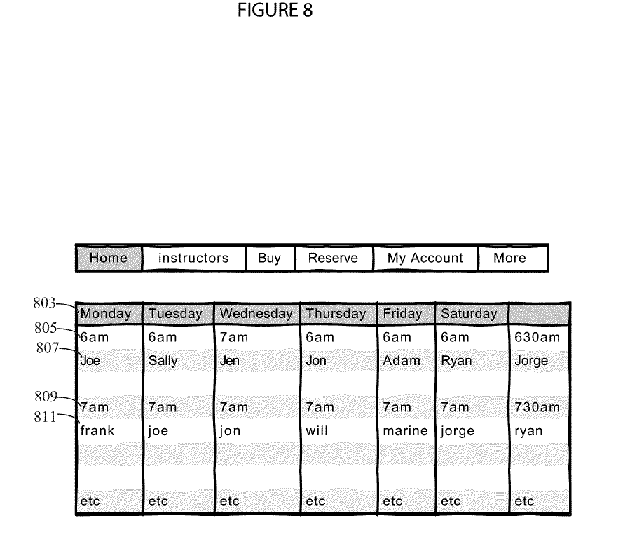

FIG. 4 shows a UI display image presented on workstation 14 enabling a user to purchase classes via a user interface such as, keyboard, mouse, touch screen, for example. A user purchases 1, 5 or 10 classes of Triathlon exercise 403 or Brick activity via selection of Buy buttons 409, 415, 421 or 412, 418, 424, respectively. FIG. 7 shows a UI display image presented on workstation 14 enabling a user to reserve particular equipment. A user selects via a user interface a particular pool from pools 1-10 (703), selects a particular cycle station from cycle stations 1-54 (705) and selects a particular treadmill from units 1-54 (707). In another embodiment, in response to user selection of a first item of exercise equipment, system 10 automatically selects remaining items of an exercise class. Cycle station 0 and treadmill 0 are reserved for an instructor. FIG. 8 shows a UI display image enabling a user to schedule classes. A user enters his name in the schedule in row 807 or row 811 for a particular time slot identified in row 805 or row 809 for a day identified in row 803.

The website supports facility financial transactions, scheduling and data collection. In response to registration, a user purchases credit for a type of class, triathlon class or a brick class. Triathlon comprises Swim and bike and run or a Brick class (Swim and Bike, Swim and Run, Bike and Run). Classes occur approximately each hour. The user purchase credits and uses the credits to reserve class seating and schedule a class via the UI images of FIGS. 4, 7 and 8. The user employs a calendar type interface as provided by FIGS. 7 and 8, for example to select a class time and available pool, bike and treadmill.

In step 205 (FIG. 2), the user enters the facility on the day and time of the reserved class and proceeds to the check in counter. The user checks in via iPad terminals or via a greeter at the front desk (or a member of a Welcome team) who uses the web interface to a facility management application. The Welcome team can sign up new users, get needed equipment (shoes, water, swim gear, for example) and educate users on the different class times and choices. Near the check-in area the facility has a retail outlet which sells the latest branded (triathlon) gear from a variety of manufacturers, as well as some basic drink and nutrient supplements and products. If class space is available a user can sign up at the time of check-in. The user rents (or borrows) necessary equipment from the greeter (shoes, wetsuit, goggles, swim cap, heart monitor, for example) and charges are accumulated in a user profile and subsequently billed for if required. Upon check-in the user proceeds to a locker area including key coded lockers, a changing room and showers. Upon changing, a user enters the transition room which is a hub between workout rooms (swim, bike and run rooms). The transition room includes numbered storage areas with a number correlating with a number of a pool, bike, and treadmill in each of the workout rooms. Depending on the workout selected, the user places necessary equipment for transition to a next exercise in the allocated storage area. For a full triathlon class, the user dons their wetsuit, swimcap and goggles for the swim and places other equipment, including their bike shoes and their running shoes, in the allocated storage areas. In step 207, the user enters the swimming pool room for the swim portion of the class and an instructor (or displayed UI image) prompts the user to enter the pool and set their speed setting. The user performs the swim portion of the exercise and swim related data is collated (if available) by server 18 (FIG. 18). A custom data collection device on each pool records swim performance related data from a session (including speed, distance, for example) and communicates the collated data for processing by system 10 and storage in a user profile. The instructor issues instructions and suggestions through underwater speakers and the user exits the pool after expiration of an allotted class time. In step 210, the user returns to the transition room and changes out of swim attire into biking attire. The instructor facilitates this process if needed. The wetsuit and swim clothes are placed in the numbered storage area, while the user takes bike shoes from the appropriate numbered storage area for the cycle portion of the class in the bike room. In step 212, the user enters the bike room and finds cycling equipment previously reserved. Cycle equipment units (e.g., Bikes) in one embodiment, are in rows of 6, with each row being slightly elevated on a progressive incline towards the back to promote visibility by the cyclists of the instructor at the front. The instructor starts the class and begins the ride which is customized to a video on the course projected on the wall (e.g. alpine, coastal) to simulate a race. System 10 acquires and processes predetermined selected data using a collection device on each bike and records data from the session (including speed, distance, torque, power, for example) and stores the acquired data in a respective corresponding user profile. During class performance data is displayed on monitors on the bikes. Individual users receive feedback data ranking participants on a variety of attributes categorized according to gender, age and performance, for example.

In step 214 in response to class completion, the user dismounts a bike and returns to the Transition room, stores the biking equipment in an allocated numbered storage area and retrieves running equipment. In step 218 in response to donning the running equipment, the user proceeds to the running room and performs the running exercise. The running room is configured similarly to the bike room, with rows of 6 treadmills facing a video wall showing a course. System 10 collects and processes performance related data from a custom data collection device on each treadmill and stores collected data from the session (including speed, distance, elevation and heart rate, for example) in the respective corresponding user profile. During class, performance data is displayed on monitors on the treadmill including data ranking participants on a variety of levels.

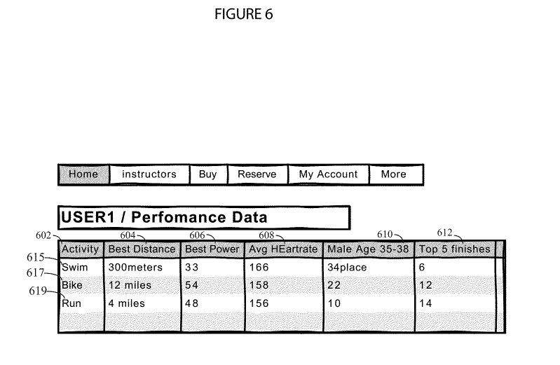

FIG. 6 shows a UI display image presenting user performance data for activities identified in column 602 comprising swimming, presented on row 615, cycling presented on row 617 and running presented on row 619. The performance data includes for a user, best distance in column 604, best power output in column 606, average heart rate during an activity in column 608, the user's ranking in his age group in column 610 and his top 5 finish places in column 612, for example. The run portion of the class is initiated and upon completion of this portion, the user in step 220 enters the transition room returns to their storage area and gathers their belongings. The user returns any rented equipment in the appropriate return bins which are located in the locker room and changes and leaves the facility. The process of FIG. 2 terminates at step 226. A user can log into the facility website, and check performance as well as their rankings on a variety of measurements. Daily or weekly emails with performance information are emailed by system 10 to respective users to engage them in the exercise community. An email informs a user of their overall rankings as well as their immediate rankings to create competition between participants in the exercise community.

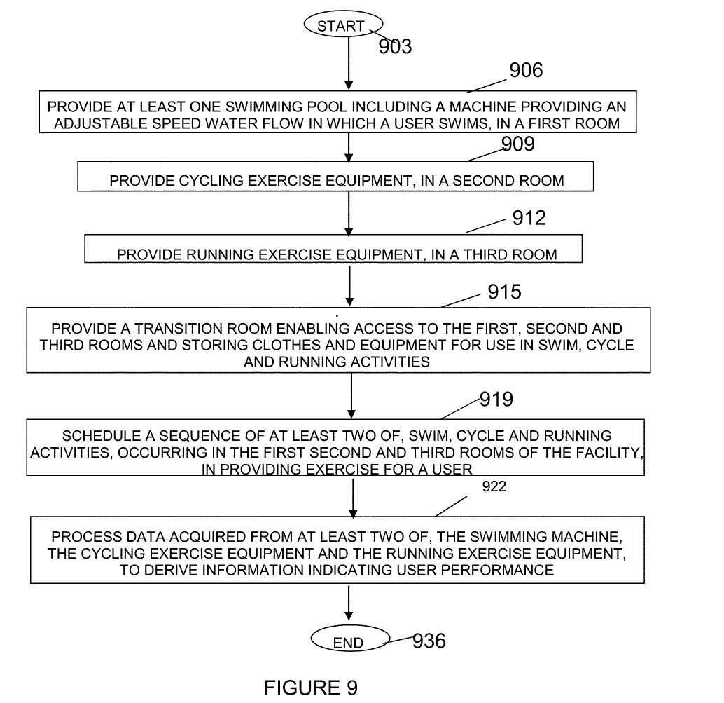

FIG. 9 shows a flowchart of a process used by a system employed in an exercise facility including multiple rooms. In step 906 following the start at step 903, the facility provides at least one swimming pool including a machine providing an adjustable speed water flow in which a user swims, in a first room 332. In step 909, the facility provides cycling exercise equipment, in a second room 336 and in step 912 provides running exercise equipment, in a third room 334. A transition room 338 is provided in step 915 enabling access to the first, second and third rooms and storing clothes and equipment for use in swim, cycle and running activities. The transition room provides a particular storage space associated with, a particular swimming pool, a particular cycling exercise machine and a particular running exercise machine. The storage space stores at least one of, user equipment and provided equipment of the facility supporting exercise activity. A room comprises a division of the facility substantially enclosed by walls, floor, and ceiling.

At least one computer system in system 10 includes a scheduler for, in step 919, scheduling a sequence of at least two of, swim, cycle and running activities, occurring in the first second and third rooms of the facility, in providing exercise for a user, in response to command. The scheduler schedules a sequence of swim, cycle and running activities mimicking triathlon (or another) exercise. The scheduler in the at least one computer provides at least one display image enabling a user to schedules a sequence of at least two of, swim, cycle and running activities by scheduling exercise classes for fixed individual time periods for corresponding individual activities with a fixed time period for transition between activities. The scheduler schedules a sequence of at least two of, swim, cycle and running activities for a plurality of users by synchronizing time of transition between activities for the plurality of users.

In step 922, the at least one computer system processes data acquired from at least two of, the swimming machine, the cycling exercise equipment and the running exercise equipment, to derive information indicating user performance. The acquired data includes at least one of, distances, resistances, time durations and speeds and user characteristics including at least one of, user age and weight. The at least one computer processes the acquired data to derive the information indicating user performance. Further, the at least one computer processes the user characteristics and the acquired data together to derive the information indicating user performance. Also the at least one computer records and tracks the acquired data to track user personal performance and compare performance of different users in different sports categories and processes data acquired from the swimming machine. The process of FIG. 9 terminates at step 936.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.” A “processor” as used herein comprises, a computer system circuit and device operating in response to instruction and is not just software. A processor comprises a logic or computer circuit structure executing predetermined instruction sufficient to perform a respective function.

The architecture of FIG. 1 and facility of FIG. 3 are not exclusive. Other architectures may be derived in accordance with the principles of the invention to accomplish the same objectives. Further, the functions of the elements of system 10 of FIG. 1 and the process steps employed may be performed in whole or in part within the programmed instructions of a microprocessor.

What is claimed is:

1. An exercise system employed in an exercise facility including a plurality of rooms, comprising:
at least one swimming pool, in a first room;
cycling exercise equipment, in a second room;
running exercise equipment, in a third room; and
at least one computer providing a scheduler for scheduling a sequence of at least two of, swim, cycle and running activities, occurring in the first second and third rooms of the facility, in providing exercise for a user, in response to command.

2. A system according to claim 1, wherein
a room comprises a division of the facility substantially enclosed by walls, floor, and ceiling and including
a transition room providing access to the first, second and third rooms and storing clothes and equipment for use in said swim, cycle and running activities.

3. A system according to claim 2, wherein
said transition room is adjacent to the first, second and third rooms and provides a space for a user to change clothes or equipment.

4. A system according to claim 3, wherein
said transition room provides a particular storage space associated with, a particular swimming pool, a particular cycling exercise machine and a particular running exercise machine, said storage space storing at least one of, user equipment and provided equipment of the facility supporting exercise activity.

5. A system according to claim 1, wherein
said at least one swimming pool includes a swimming machine providing an adjustable speed water flow in which a user swims and
said at least one computer processes data acquired from said swimming machine to provide information indicating user performance.

6. A system according to claim 1, wherein
said at least one computer processes data acquired from said cycling exercise equipment and said running exercise equipment to provide information indicating user performance.

7. A system according to claim 6, wherein
the acquired data includes at least one of, distances, resistances, time durations and speeds and the at least one computer processes the acquired data to derive said information indicating user performance.

8. A system according to claim 7, wherein
said at least one computer processes user characteristics including at least one of, user age and weight and the acquired data together to derive said information indicating user performance.

9. A system according to claim 8, wherein
said at least one computer records and tracks the acquired data to track user personal performance and compare performance of a plurality of different users in a plurality of different sports categories and processes data acquired from said swimming machine.

10. A system according to claim 1, wherein
said scheduler schedules a sequence of swim, cycle and running activities mimicking triathlon exercise.

11. A system according to claim 1, wherein
said scheduler schedules a sequence of at least two of, swim, cycle and running activities by scheduling exercise classes for fixed individual time periods for corresponding individual activities with a fixed time period for transition between activities.

12. A system according to claim 1, wherein
said scheduler schedules a sequence of at least two of, swim, cycle and running activities for a plurality of users by synchronizing time of transition between activities for said plurality of users.

13. A method for providing an exercise facility including a plurality of rooms, comprising:
providing at least one swimming pool including a machine providing an adjustable speed water flow in which a user swims, in a first room;
providing cycling exercise equipment, in a second room;
providing running exercise equipment, in a third room;
providing a transition room enabling access to the first, second and third rooms and storing clothes and equipment for use in swim, cycle and running activities; and
scheduling a sequence of at least two of, swim, cycle and running activities, occurring in the first second and third rooms of the facility, in providing exercise for a user.

14. A method according to claim 13, wherein
said transition room is adjacent to the first, second and third rooms and provides a particular storage space associated with, a particular swimming pool, a particular cycling exercise machine and a particular running exercise machine, said storage space storing at least one of, user equipment and provided equipment of the facility supporting exercise activity.

15. A method according to claim 13, including
processing data acquired from at least two of, said machine, said cycling exercise equipment and said running exercise equipment, to derive information indicating user performance, the acquired data includes at least one of, distances, resistances, time durations and speeds and user characteristics including at least one of, user age and weight.

16. A method according to claim 1, wherein
said scheduler schedules a sequence of at least two of, swim, cycle and running activities by scheduling exercise classes for fixed individual time periods for corresponding individual activities with a fixed time period for transition between activities and by synchronizing time of transition between activities for of plurality of different users.

17. An exercise facility including a plurality of rooms, comprising:
a first room including at least one swimming pool with a machine providing an adjustable speed water flow in which a user swims;
a second room including cycling exercise equipment;
a third room including running exercise equipment; and
a transition room providing access to the first, second and third rooms and storing clothes and equipment for use in swim, cycle and running activities and providing a space for a user to change clothes or equipment.

18. A facility according to claim 17, wherein
a room comprises a division of the facility substantially enclosed by walls, floor, and ceiling,
said transition room is adjacent to the first, second and third rooms and provides a particular storage space associated with, a particular swimming pool, a particular cycling exercise machine and a particular running exercise machine, said storage space storing at least one of, user equipment and provided equipment of the facility supporting exercise activity.

19. A facility according to claim 17, including
at least one computer providing at least one display providing at least one scheduler display image enabling scheduling a sequence of at least two of, swim, cycle and running activities, occurring in the first second and third rooms of the facility, in providing exercise for a user, in response to command.

20. A method according to claim 19, wherein
said at least one scheduler display image enables scheduling a sequence of at least two of, swim, cycle and running activities by scheduling exercise classes for fixed individual time periods for corresponding individual activities with a fixed time period for transition between activities and by synchronizing time of transition between activities for of plurality of different users.
